(19) United States
(12) Patent Application Publication
(10) Pub. No.: US 2005/0086261 A1
(43) Pub. Date: Apr. 21, 2005

(54) Child locator apparatus and method

(76) Inventor: Richard Mammone, Warren, NJ (US)

Correspondence Address: Arthur M. Peslak, Esq.;MANDEL & PESLAK, LLC, Suite 5, 80 Scenic Drive, Freehold, NJ, 07728, US

(21) Appl. No.: 10/689,216

(22) Filed: Oct. 20, 2003

(51) Int. Cl. G06F 17/00

(52) U.S. Cl. 707/104.1

(57) ABSTRACT

A method and apparatus for rapidly soliciting the help of nearby people in a crisis situation such as a kidnapping is disclosed. The invention allows a person such as a parent to alert people who are within a specified radius of the person to voluntarily assist in looking for a missing child, pet, elderly person or other party in the area immediately surrounding the site where the party was last seen. The system allows for this assistance to be solicited within seconds of recognition of the fact that the party is missing. The system operates over the public mobile phone network using available location based services (LBS) technology such as those mandated by the FCC for enhanced 911 mobile emergency calls. Users, once notified of the missing child, could log their locations into the system if they spot the child at a specific time after they receive the alert. The resultant child tracking record is reported to the initial caller periodically by mobile. In addition, local “hot spot” wireless networks based at retail stores, museums, amusement parks etc can also be used to specify the users' location. The alert signal received from a particular wireless hot point in a retail store, for example, would initiate a request for help in searching for the missing person to be broadcast to the same hot point in the same retail store or nearby hotspots over a network managed by a wireless hot spot aggregator or a wireless carrier.

### DETAILED DESCRIPTION OF THE INVENTION

### FIELD OF INVENTION

This invention relates to systems and methods used in emergency situations such as a kidnapping of a child where immediate identification and tracking information about the missing person is critical in finding the missing person.

### BACKGROUND OF INVENTION

According to the National Incidence Studies of Missing, Abducted, Runaway and Thrown-away Children there are nearly 800,000 children reported missing each year (more than 2,000 per day). 58,200 children are abducted by non-family members. 115 children are the victims of the most serious, most long-term abductions (stereotypical kidnappings), of which 56% are recovered alive, 40% are killed. 203,900 children are the victims of family abductions.

According to the State of Washington's Office of the Attorney General, “74 percent of abducted children who are murdered are dead within three hours of the abduction.” Thus, time is of the essence when trying to find missing children. There is a fairly broad awareness of this issue and a number of programs have been set up to assist in finding missing children by enlisting the help of the public. One such program is the AMBER alert system supported by the National Center for Missing & Exploited Children (NCMEC).

The AMBER plan was created in 1996 as a powerful legacy to 9-year-old Amber Hagerman, who was kidnapped and murdered in Arlington, Tex. Credited with saving 31 lives since its inception, AMBER Alerts are currently transmitted over broadcast medium to licensed television and radio stations, and cable systems using the Emergency Alert System (EAS). The EAS, operated by the Federal Communications Commission (FCC), is primarily used to issue severe weather alerts and for other emergency purposes. AMBER Alerts are also transmitted via electronic highway billboard signs in select areas.

There is also an online AMBER Alert systems such as the “AOL AMBER Alerts”, program which utilizes the Internet to expand the broadcast network that helps locate and rescue abducted children. AOL announced that 62 of the 63 states, counties and cities that currently have AMBER Alert systems in place (as of Sep. 30, 2003) have agreed to participate in the AOL AMBER Alerts program. As a result, official AMBER Alerts texts as issued by law enforcement, will be available as an “opt-in” feature beginning in early November 2003, and will be targeted to members based on the states in which they reside. The texts will run over the new “AOL Alerts & Reminders” product, which will allow members to choose to receive the alerts immediately on their computer screens, via email, mobile phones, or paging devices.

The AMBER Alert system goes through local law enforcement agencies and the information must be verified before broadcasting to all media outlets so as not to waste these valuable resources which are generously given to help the few children who are in true danger by their abductors. The process of vetting out improper claims and getting all of the information necessary to go on the air with the amber alert can generally take several hours. This time frame is too slow in the context of finding a missing child where a few hours or less may be all the time they have left. The Amber Alert system must be selective since it commits a large amount of broadcast resources for a few days. The AMBER Alert system is a great augmention to the present invention.

The present invention, requires the use of less resources for a shorter period of time than an AMBER Alert. The resources may involve only the broadcast of several text messages to people in the immediate area of the abduction. The reduced level of resources needed by the new system allows it to be used more frequently and more quickly than an AMBER Alert. In addition, the users will have agreed to receive the calls beforehand and can elect to not receive the calls at any time in the future or for any time interval that they do not wish to be disturbed. Thus the system is highly noninvasive and could be used more freely than the AMBER Alert system, since the impact of false positives is more limited. Another alert system that is widely used primarily in retail stores and local areas where children are kidnapped is called code Adam also sponsored by the National Center for Missing & Exploited Children (NCMEC).

Code Adam, one of the country's largest child-safety programs, was created and promoted by the Wal-Mart® retail stores and named in memory of 6-year-old Adam Walsh whose abduction from a Florida shopping mall and murder in 1981 brought the horror of child abduction to national attention. John Walsh, Adam's father went on to create “America's Most Wanted” the successful TV show and he and his wife started the NCMEC. When a customer reports a missing child to a store employee, a “Code Adam” alert is announced over the public-address system. A brief description of the child is obtained and provided to all designated employees who immediately stop their normal work to search for the child, and monitor all exits to help prevent the child from leaving the store. If the child is not found within 10 minutes of initiating a storewide search, or if the child is seen accompanied by someone other than a parent or guardian, store personnel contact the local police department and request assistance. Since the Code Adam program began in 1994, it has been a powerful preventive tool against child abductions and lost children in more than 36,000 stores across the nation. Wal-Mart®, with the help of NCMEC, has generously offered other retailers the opportunity to implement this powerful tool against child abduction.” Code Adam is not in every store, amusement park, video game arcade etc. The new system disclosed here could alert mobile communicators in these places without any infrastructure changes or employee training. The present invention would be used in addition to other alert systems such as AMBER and Adam alert systems by providing all of the required information for these alerts in one file to the authorities that require them. It has the possibility of becoming more widely used since it requires limited overhead and has a network of highly motivated users. There are a number of methods available to get the mobile location or “address” of a wireless user. Location Based Services (LBS) Technology is becoming a realty largely due to the FCC order to wireless phone carriers to make mobile location based addresses available for 911 emergency phone calls over wireless phones. This is called the enhanced 911 or E911 system, which will soon replace the original 911 system. There are two separate venues for wireless location technologies. They are indoors and outdoors. Global satellite positioning (GPS) works mainly outdoors, for example, since it is difficult to obtain the signal strength required for acceptable operation indoors. There are other outdoor technologies that use several cellular base stations and/or modifications to the cellular phone handsets. The indoor location technologies use wireless local area networks such as 802.11a, 802.11b or 802.11g commonly referred to as “Wi-Fi” technology. These indoor location technologies are aggregated into networks of Wi-Fi networks by companies such as www.boingo.com and also by phone companies such as Sprint and AT&T. They are also integrated into the outdoor location aware systems via integrating Wi-Fi hot spots into cellular phone networks. Motorola has a handset that seamlessly transition between Wi-Fi and cellular phone networks. Thus indoor and outdoor location aware wireless communication devices such as cell phones, PDAs and handheld computers are becoming more and more common. The present invention makes use of these location aware communication devices to help people find missing persons quickly. The AMBER Alert system is primarily adapted to be an outdoor system whereas the Adam alert system is primarily adapted to be for indoor systems. The present invention can be used seamlessly for both indoors and outdoors for rapid announcements. In addition, the current system allows for notification of either or both AMBER Alert and Adam alert systems concurrently with the use of the present invention.

The wireless E911 program is divided into two parts—Phase I and Phase II. Phase I requires carriers, upon appropriate request by a local Public Safety Answering Point (PSAP), to report the telephone number of a wireless 911 caller and the location of the antenna that received the call. Phase II requires wireless carriers to provide far more precise location information, within 50 to 100 meters in most cases. Although the deadline for both phases are long overdue not all Carriers are fully certified for phase II yet, However, They should all be able to locate a user to within 100 yards very soon. The carriers have taken different approaches to meet or exceed these criteria however, the present invention does not rely on any specific technology to find a user's location.

The present invention is adapted to have buddy lists for parents such as for Johnny's best friends and their parents so a parent could issue a “request for information” such as “does anyone know where my Johnny is?” Not that he is kidnapped or something just he might have gone to Sally's house for dinner after school and forgot to tell his parents. So the first level might be called a RFI (request for information) and just go to a buddy list of opt-in users. The present invention would take all of the replies (Preferably SMS messages) and automatically filter them, aggregate them and give a summary to the RFI issuer such as “8 returns say they have not seen Johnny, 6 gave no reply and Sally's mom replied “yes he is at my house,” the issuer could then drill down for more details if they want to see more information such as who sent the replies, when, what exactly did they say by communicator with the web site of the present invention or they could go right to calling Sally's mom to check on Johnny if they choose.

The next level might be called an Alert and this might only notify people very close to the issuer at the time of the request with no 911 call, no amber alert follow-up, etc. This is when you missed your kid for a few minutes and are not sure that he or she is truly missing. The present invention once again takes all replies and forms a report for the issuer which can be further used to study who replied what at what time etc.

The third and highest level is an Alarm. In the care of an Alarm, a greater area is notified, a 911 call is made either by the issuer first or by an operator along with the issuer, an amber alert is issued and the present invention will send a minute by minute report on the replies it is receiving to the issuer and any authorities involved in the case. Another distinction is that people could register (for free) to volunteer to be locators so anyone could register to volunteer to help other people find their kids for free. A fee would be charged for the ability to issue RFIs, alerts and alarms.

Another feature of the present invention is that enrollees might be asked to enroll from a landline phone so we can verify their address, as well as use their cell phone to verify it is their cell number. The present invention will also guard against pranksters (kids) sending alerts on their friends as much as possible maybe with fines but also with filters on enrollment.

### BRIEF DESCRIPTION OF THE DRAWINGS

FIG. 1 is a block diagram illustrating the method of the present invention.

### DETAILED DESCRIPTION OF THE INVENTION

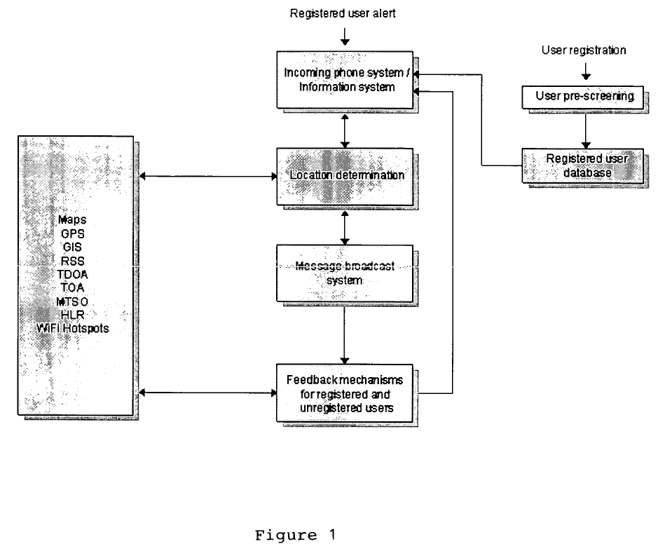

The present invention is directed to a method and apparatus for a flexible inquiry and alarm system to assist in locating missing children in an expedited fashion. The overall system of the present invention is illustrated in FIG. 1. It is presently contemplated that the system can be implemented on an internet web server.

The present invention is adapted to provide means for users to enter identifying information into an online database about each child or other persons of interest. The system can be adapted to include storing photographs of the person, sound clips of the persons voice as well as other appropriate identification information. This data will be stored for use at a later time when an alert request as described below is received. The information in the database will be incorporated in a message to be broadcast. This method will reduce the time needed to form the alert message at the time of crisis. The alert messages will be adapted to include text, audio and photo descriptions of the children as well as any other helpful identifying features.

The system of the present invention will also include means for prescreening users of the system. The system will use available technology to screen users for criminal records, including but not limited to persons with prior records for kidnapping or sex crimes. Another possible extension of the system would be to utilize the database for tracking sex offenders from Megan's Law warnings and coordinate the location of such offenders with the location of any reported missing children.

In particular, the apparatus will be adapted for either a live or automatic incoming phone system for receiving telephone calls from a parent or other interested party. The person would be calling in to make a request to broadcast an inquiry or an alert. The incoming phone system will briefly interview the caller to authenticate that the caller is an authorized system user. At this stage, for example, the system will need to determine that the caller is not a kidnapper or a prank caller. The system will update the information in the database about the missing party such as what the child currently is wearing or the last known location for the child.

The apparatus will also comprise a means for obtaining the location of the caller from either the caller directly, from the mobile phone carrier and/or mobile phone handset. The location can be obtained by a number of methods described below.

After receipt of a request from the incoming caller and authentication of the caller as well as his or her location, the next step in the method will be the broadcasting of a message (voice, SMS, MMS, Video, etc.) requesting aid in finding the missing person. The system will comprise a method of providing the request to other mobile communicators who are concurrently within a specific geographic radius of the caller.

When an alert is broadcast, the system will be adapted to all users who receive the alert to input their locations by pressing a phone key such as the digit “1.” By entering the appropriate number, the user will signify to the system that they have located the missing child at their current location at the current time. The collection of time-stamped locations from any user will be sent by the system to the party who called in the alert as well as local law enforcement authorities to aid in the search for the missing child

Among the means described for specifying the location of the user are input of the telephone area code, zip code, cell site address or Global Positioning System (GPS) input. Another method of determining the users location is through the time difference of arrival (TDOA) of the location of the senders and receivers. Another method that is presently contemplated can be incorporated in the present invention for locating users is by radiated signal strength (RSS) from the users call in signal. Also other methods such as Angle of Arrival (AOA), enhanced GPS, Dead reckoning, can be used to obtain the user's location or any combination of any of the above are contemplated to be within the scope of the present invention.

The present invention can also be adapted to include means of adding a Geographic Information System (GIS) to help the users interact with the system. For example, by utilizing maps, the system can display where the child was last seen. If a user subsequently spots the child, the user can input the location of their sightings quickly onto the map, which will then be readily available to all other users.

From a business viewpoint, the web-based system of the present invention can be adapted to disseminate relevant advertising as well as discount coupons. Relevant parenting information can also be disseminated on the system.

Those of ordinary skill in the art will recognize that the embodiments just described merely illustrate the principles of the present invention. Many modifications may be made thereto without departing from the spirit and scope of the invention as set forth in the following claims.

1) A method for locating a kidnapped or missing person comprising the following steps:
a) Providing apparatus which comprises an internet accessible database;
b) Registering a plurality of users to input information on a plurality of persons into the database;
c) Inputting identification and location information on the plurality of persons into the database for retrieval at a later date;
d) Providing telephone means for activating the apparatus to assist in locating the kidnapped or missing person;
e) Activating the apparatus by telephone means from a first registered user who is reporting the kidnapped or missing person to assist in locating the person;
f) Determining the location of the first registered user;
g) Broadcasting an alarm to a plurality of other registered users in a geographic area in a specific proximity of the first registered user wherein the alarm will contain stored identification and location information on the kidnapped or missing person;
h) Providing means for the plurality of other users to report back to the apparatus a sighting of the kidnapped or missing person; and
i) Providing means for disseminating the sighting information to the first registered users and to law enforcement authorities.

2) An apparatus for use in locating a kidnapped or missing person comprising:
a) An internet web server comprising a database adapted to store identification and location information for a plurality of persons and a plurality of registered users;
b) Means for activating the apparatus through a telephone input from a first registered user;
c) Means for determining the location of the first registered user;
d) Means for broadcasting an alarm to a plurality of other registered users who are located within a specific geographic proximity to the first registered user wherein such alarm includes identification and location information on the kidnapped or missing person;
e) Means for the other registered users to report back to the apparatus a sighting of the kidnapped or missing person; and
f) Means for discriminating the sighting information to the first registered user or to law enforcement authorities.
